(19) United States
(12) Patent Application Publication
(10) Pub. No.: US 2025/0135892 A1
(43) Pub. Date: May 1, 2025

(54) CHARGE DISCHARGE DEVICE

(71) Applicant: TOYOTA JIDOSHA KABUSHIKI KAISHA, Toyota-shi (JP)

(72) Inventor: Takashi NOZAWA, Nagoya-shi (JP)

(73) Assignee: TOYOTA JIDOSHA KABUSHIKI KAISHA, Toyota-shi (JP)

(21) Appl. No.: 18/895,576

(22) Filed: Sep. 25, 2024

(30) Foreign Application Priority Data
Oct. 31, 2023 (JP) 2023-186648

(51) Int. Cl. B60L 1/02; H02J 7/00; H02M 3/335; H02M 7/797; H05B 1/02

(52) U.S. Cl. CPC B60L 1/02; H02J 7/0063; H02J 7/007; H02M 3/33584; H02M 7/797; H05B 1/0236; B60L 2210/12; B60L 2210/30; H02J 2310/48; H05B 2203/023

(57) ABSTRACT

A charge discharge device includes: a bidirectional charger for converting a power from an external power supply into DC power, and converting DC power of the battery into AC power; and a controller for controlling the bidirectional charger. Further, the bidirectional charger includes an AC/DC converter, a DC/DC converter, an output terminal electrically connected to a power line, and a switch provided between the power line and the output terminal, the output terminal is electrically connected to an electrically heated catalyst, and in a case power of the battery is supplied to the electric heating catalyst and the external device at a same time, when a required voltage of the electric heating catalyst is lower than the output voltage corresponding to a power supply possible range of the external device, the controller intermittently operates the switch.

### CROSS-REFERENCE TO RELATED APPLICATION(S)

The present application claims priority to and incorporates by reference the entire contents of Japanese Patent Application No. 2023-186648 filed in Japan on Oct. 31, 2023.

### BACKGROUND

The present disclosure relates to a charge discharge device.

Japanese Laid-open Patent Publication No. 2017-193245 discloses a hybrid vehicle capable of external charging, a charger for converting the power supplied from the external power source into DC power conforming to the battery, and a EHC power supply for supplying the electric heating-type catalyst by converting the power of the battery into a predetermined voltage It has been disclosed.

### SUMMARY

There is a need for providing a charge discharge device capable of simultaneously supplying power of the battery to the electric heating type catalyst and the external device at all operating points.

According to an embodiment, a charge discharge device includes: a bidirectional charger for converting a power supplied from an external power supply connected to an inlet into DC power conforming to a battery for storing power, converting DC power of the battery into AC power, and outputting the DC power to an external device connected to an outlet; and a controller for controlling the bidirectional charger. Further, the bidirectional charger includes an AC/DC converter for converting AC power from the inlet into DC power, a DC/DC converter for converting DC power from the AC/DC converter into a predetermined voltage and supplying to the battery, an output terminal electrically connected to a power line connected to an input and output terminal on an AC/DC converter side of the DC/DC converter, and a switch provided between the power line and the output terminal, the output terminal is electrically connected to an electrically heated catalyst, the DC/DC converter converts the DC power of the battery into a predetermined output voltage and outputs to the output terminal and the AC/DC converter, the AC/DC converter converts the DC power from the DC/DC converter into AC power and outputs to the outlet, and in a case power of the battery is supplied to the electric heating catalyst and the external device at a same time, when a required voltage of the electric heating catalyst is lower than the output voltage corresponding to a power supply possible range of the external device, the controller intermittently operates the switch.

### BRIEF DESCRIPTION OF THE DRAWINGS

FIG. 1 is a diagram schematically illustrating a charge discharge device according to an embodiment;

FIG. 2 is a diagram illustrating a relationship between AC power supply allowable range and EHC required voltage range;

FIG. 3 is a diagram for explaining an intermittent operation of a switch;

FIG. 4 is a flowchart illustrating a power supply control flow; and

FIG. 5 is a time chart illustrating a power supply to EHC.

### DETAILED DESCRIPTION

In the configuration described in Japanese Laid-open Patent Publication No. 2017-193245, since the charger and EHC power supply is configured as separate hardware, the device becomes large and expensive. Therefore, it is conceivable that the charger and EHC power source are integrated to a bi-directional charger, but in this case, there is a possibility that it cannot supply power to both the electrically heated catalyst converter and the external device depending on the operating point.

Hereinafter, with reference to the drawings, a specific description will be given of a charging and discharging apparatus according to an embodiment of the present disclosure. Note that the present disclosure is not limited to the embodiments described below.

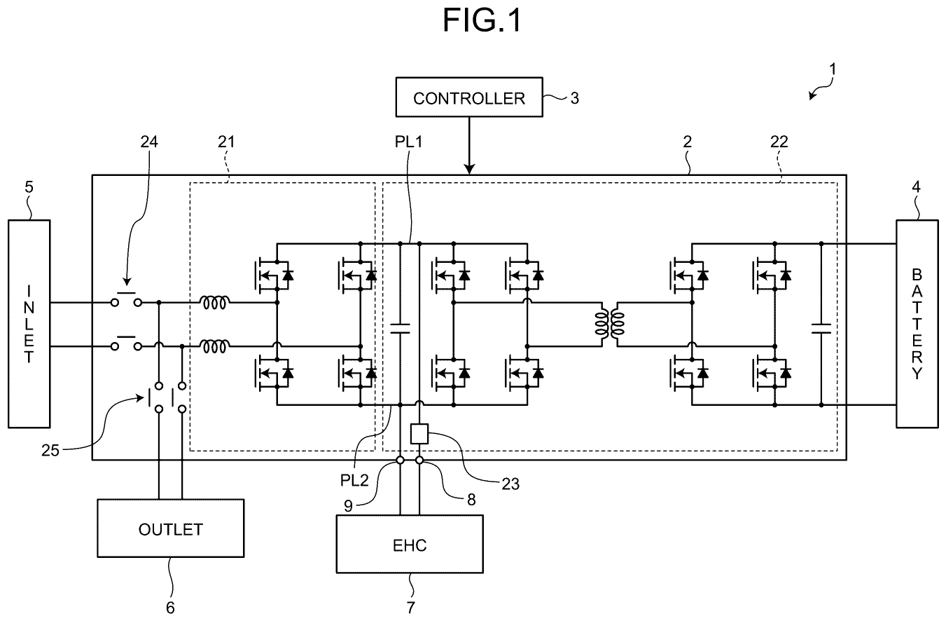

FIG. 1 is a diagram schematically illustrating a charge discharge device according to an embodiment. The charge discharge device 1 is mounted on a vehicle having an engine and a motor, together with a charger for external charging, a power supply for supplying power to the electric heating type catalyst for purifying the exhaust gas of the engine. The electric heating type catalyst is installed in the exhaust passage of the engine, and it is a catalyst which generates heat in response to energization. The vehicle equipped with the charging and discharging device 1 is a plug-in hybrid vehicle. The charge discharge device 1 includes a bidirectional charger 2 and a controller 3.

The bidirectional charger 2 is a charger for charging the battery 4 using the AC power supplied from the AC power source outside the vehicle (external power source). The battery 4 is a DC power source capable of charging and discharging, a high voltage battery for supplying power to the motor for traveling. The battery 4 is constituted by a secondary battery such as nickel hydrogen or lithium ion. The battery 4 discharges power to the bidirectional charger 2 or charges power supplied from the bidirectional charger 2.

The bidirectional charger 2 is electrically connected to the battery 4 and an inlet 5 and an outlet 6 and the electrically heated catalyst (hereinafter, referred to as EHC) 7. The bidirectional charger 2 provides power to EHC 7 for the batteries 4. When supplying power to the EHC 7, the charge discharge device 1 can supply power to an external device connected to the outlet 6. That is, the charge discharge device 1 can simultaneously supply the power of the battery 4 to the EHC 7 and the external device.

The inlet 5 is an AC inlet to which an external power source is connected. A connector of the power supply facility is connectable to the inlet 5. For example, the connector connected to AC charging cable of the charging station is connected to the inlet 5. The inlet 5 is electrically connected to the battery 4 through the bidirectional charger 2.

Bidirectional charger 2 converts the AC power supplied from the inlet 5 into DC power conforming to the battery 4.

The outlet 6 is an AC outlet to which an external device is connected. An external device operable by AC power is connectable to the outlet 6. For example, plugging of an external device operable with 200V AC power is connected to the outlet 6. Further, it is possible to connect an external device operable with 100V AC power to the outlet 6. The outlet 6 is electrically connected to the battery 4 through the bidirectional charger 2. In a state where a plug of the external device is connected to the outlet 6, the bidirectional charger 2 supplies the power of the battery 4 to the external device.

The EHC 7 is a catalyst which is provided in the exhausting passage of the engine and generates heat in response to energization. The EHC 7 is electrically connected to the batteries 4 via a bidirectional charger 2. The Bi-directional charger 2 includes output terminals 8 and 9 to which the EHC 7 is connected. The bidirectional charger 2 outputs the power of the battery 4 from the output terminals 8 and 9 to the EHC 7.

The bidirectional charger 2 includes an AC/DC converter 21, a DC/DC converter 22, and a switch 23.

The AC/DC converter 21 converts the AC power supplied from an external power source into DC power and outputs it to DC/DC converter 22. A first relay 24 is provided between AC/DC converter 21 and the inlet 5. When the first relay 24 is closed (ON), the AC/DC converter 21 and the inlet 5 are connected to be energized. When the electric power supplied from the external power source is charged to the battery 4, the first relay 24 is turned ON.

The AC/DC converter 21 converts the DC power supplied from DC/DC converter 22 into AC power to be outputted to the outlet 6. A second relay 25 is provided between the AC/DC converter 21 and the outlet 6. When the second relay 25 is closed (ON) state, the AC/DC converters 21 and the outlets 6 are energizably connected. When supplying the power of the batteries 4 to the external device, the second relay 25 is turned ON.

The DC/DC converter 22 converts the DC power inputted from AC/DC converter 21 to power for charging and supplies it to the cell 4. When performing an external charge, power of the external power source is supplied from AC/DC converter 21 to the batteries 4 through DC/DC converter 22.

The DC/DC converter 22 converts the power of the cell 4 into a predetermined output-voltage and supplies it to AC/DC converter 21. When performing the external power supply, the power of the cell 4 is supplied from DC/DC converter 22 to the external device via AC/DC converter 21 and the outlet 6. In addition, the DC/DC converters 22 convert the power of the cell 4 to a predetermined output-voltage and provide it to the EHC 7. When supplying power to EHC 7, the power of the cell 4 is supplied to the EHC 7 via DC/DC converters 22 and the output terminals 8 and 9.

The switch 23 is a switch provided between DC/DC converters 22 and the EHC 7. The switch 23 is configured to be capable of intermittent operation. The switch 23 is provided between an output terminal 8 and the power line PL 1. The Output terminals 8 and 9 are electrically connected to the power lines PL1 and PL2 of the DC/DC converters 22. The Power line PL1 and PL2 are a power lines connected to the input and output ends of the AC/DC converter 21 of the DC/DC converter 22. The switch 23 is a relay for electrically connecting/disconnecting the EHC 7 and the power line PL1. The switch 23 switches the open-close state based on a control signal from the controller 3.

The controller 3 is an electronic controller for controlling the bidirectional charger 2. The controller 3 includes a processor and a memory. The processor is composed of a CPU. The memories are composed of a RAM and a ROM. The control device 3 loads and executes the program stored in the storage unit in the work area of the memory (main storage device), and realizes a function that matches a predetermined purpose by controlling each configuration unit through the execution of the program.

Signals from various sensors are input to the control device 3. The control device 3 executes various controls based on signals input from various sensors.

The control device 3 executes an external charging control for charging power from the inlet 5 to the battery 4, an external power supply control for supplying power of the battery 4 to the external device, and an internal power supply control for supplying power of the battery 4 to the EHC 7. The control device 3 is capable of executing power supply control for supplying power of the batteries 4 to the external device and the EHC 7 at the same time. When performing simultaneous power supply, the control device 3 based on the required voltage from the external device and the required voltage from the EHC 7, and controls the outputting voltage of the bidirectional charger 2 so as to satisfy both the required voltage.

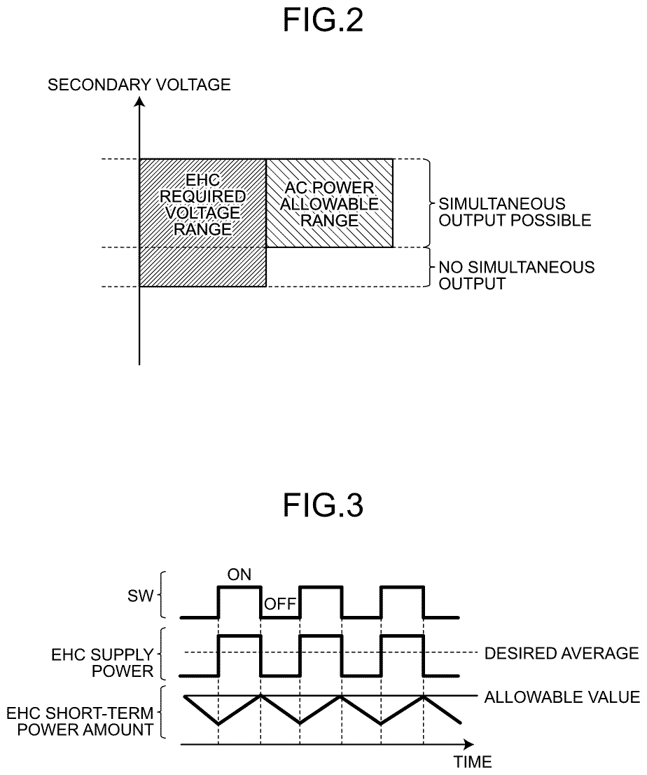

FIG. 2 is a diagram illustrating a relationship between an AC power supply allowable range and an EHC required voltage range. Incidentally, the secondary-side voltage illustrated in FIG. 2 represents the outputting voltage of the DC/DC converters 22 when supplying power from the bidirectional charger 2 to the EHC 7 and the external device.

As illustrated in FIG. 2, the outputting voltage of DC/DC converter 22 is controlled to a range satisfying the required voltage range of the EHC 7 and the range in which power can be supplied to the external device. The external equipment connected to the outlet 6 is driven by AC power supply of 100V or 200V. When the AC/DC converter 21 converts the DC power from the DC/DC converter 22 into AC power, and outputs the AC power stepped down to a predetermined voltage to the outlet 6. The AC power supply possible range illustrated in FIG. 2 represents the DC voltage, and represents the output voltage of the DC/DC converter 22 corresponding to the AC voltage within the range that can be supplied to the external device. The required voltage range of the EHC 7 is a range including AC power supply possible range, and is set to a range including a voltage lower than AC power supply possible range. In AC power feed, the crest value can be stepped down by PWM control of the AC/DC converters 21.

When the required voltage of the EHC 7 is within the scope of AC power supply, it can be output simultaneously to the EHC 7 and the external device if the output voltage of the DC/DC converter 22 is controlled to be the required voltage of the EHC 7. On the other hand, when the required voltage of the EHC 7 is lower than the AC power supply possible range, if the output voltage of DC/DC converter 22 is controlled to be the required voltage of the EHC 7, the output voltage will be disconnected from AC power supply possible voltage, it becomes impossible to output at the same time to the EHC 7 and the external device. As the EHC 7 heats up, the resistivity decreases.

In order not to exceed the allowable power of the EHC 7, the output voltage to the EHC 7 must be reduced. However, if the output-voltage of the DC/DC converter 22 is lowered too much, it becomes impossible to secure the voltage required for the AC power supply.

Therefore, in the charge discharge device 1, the power supply of the EHC 7 and the power supply to the external device are simultaneously enabled at all the operating points. Specifically, in the charge discharge device 1, when the required voltage of the EHC 7 falls below the AC power supply allowable range during simultaneous power supply to the EHC 7 and the external device, the switch 23 is intermittently operated. The intermittent operation of the switch 23 allows the power supplied from the DC/DC converter 22 to the EHC 7 to be reduced while maintaining the power output of the DC/DC converter 22. The controller 3 controls the output-voltage of the DC/DC converters 22 in preference to AC power feed. The controller 3 controls the outputting voltage of the DC/DC converters 22 so as to be kept at a voltage corresponding to AC possible feeding range illustrated in FIG. 2. The controller 3 controls the timing of the intermittent operation of the switch 23 to ensure that the EHC 7 does not exceed the allowable short-term power allowance for the EHC 7 and can provide ON power required by the EHC 7, as shown illustrated in FIG. 3, during ON period in which power is supplied to the EHC 7.

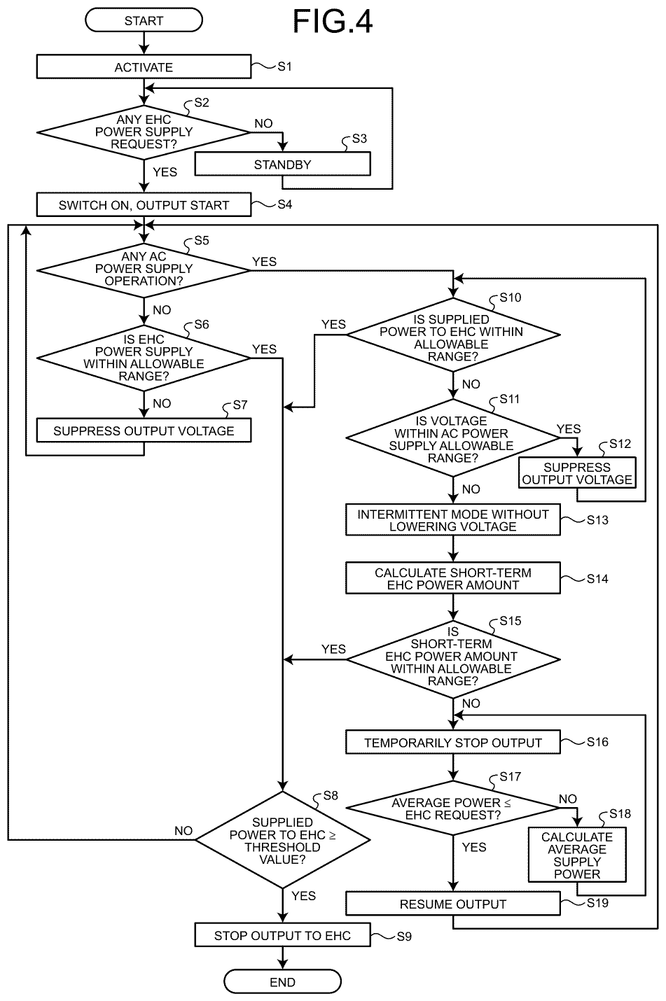

FIG. 4 is a flowchart illustrating a power supply control flow. The control illustrated in FIG. 4 is implemented by the control device 3.

The controller 3 activates the bidirectional charger 2 (step S1).

The controller 3 determines whether there is a power supply request of the EHC 7 (step S2).

If it is determined that there is no power supply requirement of the EHC 7 (No in step S2), the controller 3 controls the bidirectional charger 2 to the standby status (step S3). Once the processing of the step S3 is performed, this control routine returns to the step S2.

If it is determined that the EHC 7 power supply is requested (Yes in step S2), the controller 3 starts outputting from the bidirectional charger 2 to the EHC 7 with the switch 23 in ON status (step S4). In step S4, the switch 23 is turned ON and the output between the DC/DC converter 22 and the output terminals 8 and 9 are energized connected, the output voltage of the DC/DC converter 22 is controlled so as to satisfy the required voltage of the EHC 7. For example, the output voltage of the DC/DC converter 22 is controlled to the same voltage as the required voltage of the EHC 7.

During power supply to the EHC 7, the controller 3 determines whether there is a AC power supply operation (step S5). In step S5, it is determined whether or not there is a power supply demand from an external device connected to the outlet 6. The controller 3 by determining whether the external device is connected to the outlet 6, determines whether or not there is the AC power supply operation.

If it is determined that there is no AC power supply operation (No in step S5), the control device 3 determines whether the supplied power to the EHC 7 is within the allowable value (step S6).

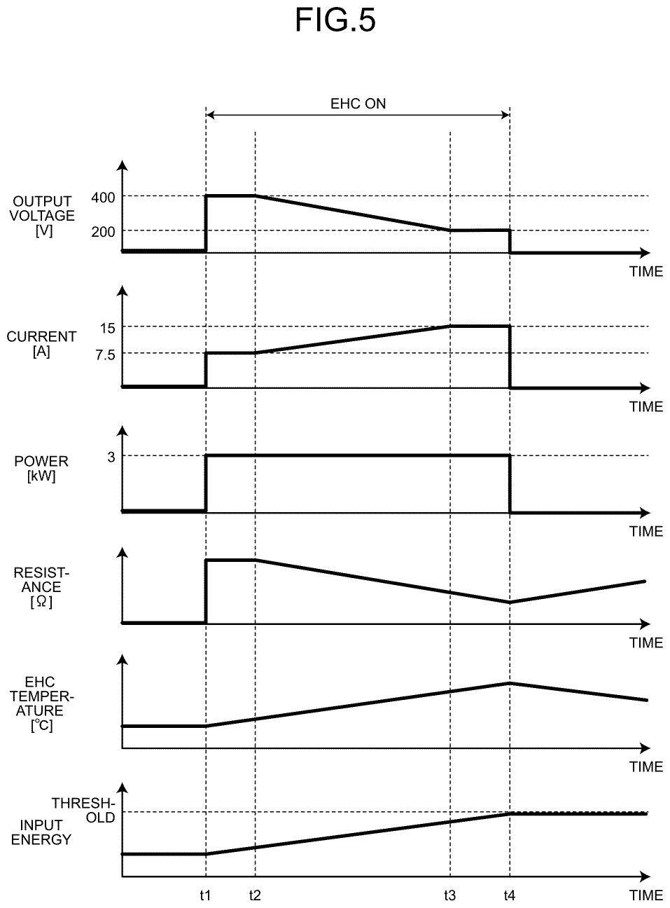

If the supplied power to the EHC 7 is determined not to be within the allowable value (No in step S6), the controller 3 suppresses the output-voltage of the DC/DC converter 22 (step S7). The temperature of the EHC 7 rises according to the energization, and the resistivity lowers with the temperature rise. In step S7, as a measure to reduce the resistor of the EHC 7, the supplied power of the EHC 7 is adjusted by lowering the output voltage of the DC/DC converter 22. As shown in FIG. 5, when power is supplied to the EHC 7 (time t1), the resistor is lowered because the EHC 7 generates heat due to energization (time t2). After time t2, the temperature of the EHC 7 increases, and the resistivity decreases with this temperature increase. When the resistance decreases, a large amount of current flows at the same voltage. Therefore, the voltage is decreased and the voltage is adjusted to equal power. In this case, the resistance gradually decreases and the current gradually increases, so that the voltage is controlled to gradually decrease. Once the process of the step S7 is implemented, the controller returns to step S5.

If the supplied power to the EHC 7 is determined to be within the allowable value (Yes in step S6), the control device 3 determines whether or not the supplied power to the EHC 7 is equal to or greater than a threshold (step S8). In step S8, it is determined whether or not the total amount of energy since the EHC 7 started to be fed has reached a threshold.

If the supplied power to the EHC 7 is determined to be equal to or greater than the threshold value (Yes in step S8), the controller 3 stops outputting to the EHC 7 (step S9). In step S9, the bidirectional charger 2 is deactivated powering the EHC 7. The controller 3 deactivates the power supply to the EHC 7 by turning OFF the switch 23. As illustrated in FIG. 5, when the input energy to the EHC 7 reaches the threshold, the power supply to the EHC 7 ends (time t5). When the process of step S9 is performed, this control routine ends.

If the supplied power to the EHC 7 is determined not more than the threshold value (No in step S8), the control routine returns to the step S5.

If it is determined that there is an AC power supply operation (Yes in step S5), the control device 3 determines whether the supplied power to the EHC 7 is within the allowable value (step S10).

If the supplied power to the EHC 7 is determined to be less than or equal to a tolerance (Yes in step S10), the control routine proceeds to step S8.

If the supplied power to the EHC 7 is determined not to be within the allowable value (No in step S10), the control device 3 determines whether the required voltage of the EHC 7 is a voltage corresponding to the AC power supply available range (step S11). In step S11, when controlling the output voltage of the DC/DC converter 22 so as to satisfy the required voltage of the EHC 7, it is determined whether the output voltage of the DC/DC converter 22 is within an AC possible feeding range. As illustrated in FIG. 2, it is determined whether or not the required voltage of the EHC 7 is a voltage within the AC power supply allowable range.

If the required voltage of the EHC 7 is determined to be a voltage corresponding to the AC power supply possible range (Yes in step S11), the controller 3 suppresses the outputting voltage of the DC/DC converter 22 (step S12). In step S12, similar to the process of step S7, as a measure to the resistance of the EHC 7 decreases with increasing temperature, the supplied power of the EHC 7 is adjusted by lowering the output voltage of the DC/DC converter 22. In this instance, the output-voltage of the DC/DC converters 22 is gradually decreased in accordance with an increase in current with a decrease in resistance. Once the process of step S12 is implemented, the controller 3 returns to step S10. The process of step S12 when returning from step S12 to step S10 reduces the output-voltage of the DC/DC converter 22. Therefore, in step S11, it is determined whether or not the output voltage of the DC/DC converter 22 is the voltage within an AC power supply possibility.

If it is determined that the required voltage of the EHC 7 is not the voltage corresponding to the AC power supply allowable range (No in step S11), the controller 3 performs the intermittent mode without lowering the output voltage of the DC/DC converter 22 (step S13). In step S13, the switch 23 is intermittently operated. The controller 3 intermittently operates the switch 23 while controlling the output-voltage of the DC/DC converter 22 so as to maintain AC power supply range. At that time, if it is during the output voltage of the DC/DC converter 22 is lowered by the process of step S12, to intermittently operate the switch 23 by stopping the control for lowering the output voltage of the DC/DC converter 22.

The controller 3 calculates the short-term power of the EHC 7 (step S14). The short-term electric energy of the EHC 7, as illustrated in FIG. 3, when intermittently operating the switch 23, the amount of the power is increased when the switch 23 is in ON state, the amount of power is decreased when the switch 23 is in OFF state, so that the value of the amount is increased or decreased.

The controller 3 determines whether the short-term power of the EHC 7 is within the allowable (step S15). In step S15, as illustrated in FIG. 3, it is determined whether or not the short-term electric energy of the EHC 7 is within an allowable limit. This tolerance is set to the electric energy that does not exceed the heat resistance of the EHC 7. The controller 3 sets an allowance corresponding to the heat capacity of the EHC 7.

If the short-term power of the EHC 7 is determined to be less than the allowable (Yes in step S15), the control routine proceeds to step S8.

If the short-term power of the EHC 7 is determined not to be less than the allowable value (No in step S15), the controller 3 pauses outputting to the EHC 7 (step S16). In step S16, the switch 23 is controlled to an OFF condition. As illustrated in FIG. 3, the controller 3 switches the switch 23 from ON state to OFF state. When the switch 23 switches to OFF state, the power supply to the EHC 7 is stopped.

The controller 3 determines whether the mean power is equal to or less than the required power of the EHC 7 (step S17). In step S17, it is determined whether or not the mean power supplied to the EHC 7 is equal to or less than the required power of the EHC 7.

If the average power is determined not to be equal to or less than the required power of the EHC 7 (No in step S17), the controller 3 calculates the average supplied power (step S18). In step S18, the desired mean feed-in power is calculated, as illustrated in FIG. 3. Upon performing the process of step S18, the control routines return to step S16.

If the mean power is determined to be equal to or less than the required power of the EHC 7 (Yes in step S17), the controller 3 resumes outputting to the EHC 7 (step S19). In step S19, the switch 23 is controlled to an ON state. As illustrated in FIG. 3, the controller 3 switches the switch 23 from the OFF state to the ON state. When the switch 23 switches to the ON state, the power supply to the EHC 7 is resumed. Once the process of the step S19 is implemented, the controller returns to step S5.

As described above, according to the embodiment, since the bidirectional charger 2 includes output terminals 8, 9 and the switch 23, the power supply to the EHC 7 in addition to AC power supply at all operating points is enabled. This enables simultaneous power feeding to the EHC 7 and the external equipment at any operating point.

In addition, low cost can be realized and the system size can be reduced.

In the present disclosure, the electric power of the battery at all operating points can be simultaneously supplied to the electric heating type catalyst and the external device.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charge discharge device comprising:
a bidirectional charger for converting a power supplied from an external power supply connected to an inlet into DC power conforming to a battery for storing power, converting DC power of the battery into AC power, and outputting the DC power to an external device connected to an outlet; and
a controller for controlling the bidirectional charger, wherein
the bidirectional charger includes an AC/DC converter for converting AC power from the inlet into DC power,
a DC/DC converter for converting DC power from the AC/DC converter into a predetermined voltage and supplying to the battery,
an output terminal electrically connected to a power line connected to an input and output terminal on an AC/DC converter side of the DC/DC converter, and
a switch provided between the power line and the output terminal,
the output terminal is electrically connected to an electrically heated catalyst,
the DC/DC converter converts the DC power of the battery into a predetermined output voltage and outputs to the output terminal and the AC/DC converter,
the AC/DC converter converts the DC power from the DC/DC converter into AC power and outputs to the outlet, and
in a case power of the battery is supplied to the electric heating catalyst and the external device at a same time, when a required voltage of the electric heating catalyst is lower than the output voltage corresponding to a power supply possible range of the external device, the controller intermittently operates the switch.

2. The charge discharge device according to claim 1, wherein, when performing an intermit operation by the switch, the control device intermittently operates the switch while controlling the output voltage so that the output voltage is maintained in the power supply possible range.

3. The charge discharge device according to claim 1, wherein, the controller controls timings of the intermittent operation of the switch in a manner that, during a period of turning on the switch, an amount of power of the electrically heated catalyst does not exceed an acceptable amount of power for a short period of time, and power that the electrically heated catalyst is required can be supplied.
